(19) United States
(12) Patent Application Publication
(10) Pub. No.: US 2024/0170792 A1
(43) Pub. Date: May 23, 2024

(54) FASTENING DEVICE FOR A BATTERY PACK, BATTERY PACK AND METHOD

(71) Applicant: VOLVO TRUCK CORPORATION, Göteborg (SE)

(72) Inventor: Robert LUNDIN, Göteborg (SE)

(73) Assignee: VOLVO TRUCK CORPORATION, Göteborg (SE)

(21) Appl. No.: 18/497,165

(22) Filed: Oct. 30, 2023

(30) Foreign Application Priority Data
Nov. 17, 2022 (EP) 22208060.8

(51) Int. Cl. H01M 50/264; H01M 50/244

(52) U.S. Cl. CPC H01M 50/264; H01M 50/244; H01M 2220/20

(57) ABSTRACT

A fastening device configured to fasten a battery module to a battery pack cover. The fastening device includes a fixating member adapted to be received within, and protrude from, a recess of the battery module, a first fastener adapted to fasten the fixating member to the battery pack cover and a second fastener adapted to fasten the fixating member to the battery module, for securement within the recess of the battery module. A fastening direction of the first fastener is perpendicular to a fastening direction of the second fastener, and the first fastener is configured to move the fixating member into contact with the battery pack cover.

### TECHNICAL FIELD

The disclosure relates generally to a battery pack. In particular aspects, the disclosure relates to a battery pack fastening arrangement, a battery pack comprising such a fastening arrangement and a fastening method. The disclosure can be applied in heavy-duty vehicles, such as trucks, buses, and construction equipment. Although the disclosure may be described with respect to a particular vehicle, the disclosure is not restricted to any particular vehicle. The disclosure could also be applied in stationary applications.

### BACKGROUND

Electrical storage systems are used to store energy for subsequent use. One example of an electrical storage system is a battery, such as a rechargeable battery for an electric vehicle.

An electrical storage system can comprise one or several battery packs. Each battery pack in turn comprises a plurality of battery cells. The battery cells are sometimes grouped together to form battery modules. By letting the battery pack consist of several battery modules, parts of the battery pack can be replaced without replacing the entire battery pack.

The battery pack generally comprises a structure for supporting the battery modules within the battery pack, such as a battery pack cover. The battery modules are thus attached to the battery pack cover which fixedly retains the battery modules within the vehicle. The arrangement for fastening the battery module to the battery pack cover should preferably be able to compensate for tolerance differences of the battery pack cover and the battery module.

A previous solution includes assembling of the battery module tight towards one side of the battery pack cover and arranging a tolerance compensating fastener, such as a tolerance compensating screw, to the opposite side of the battery pack cover.

One problem with this solution is that momentum is introduced along the fastener axis, whereby there is a risk that the threads are worn out resulting in unfastening of the fastener. Another problem with this solution is that assembly and removal of a battery module in the battery cover is complicated.

The present solution aims at providing a fastening device which at least partly overcomes these previous problems.

### SUMMARY

According to a first aspect of the disclosure, a fastening device configured to fasten a battery module to a battery pack cover is provided, the fastening device comprising a fixating member adapted to be received within, and protrude from, a recess of the battery module, a first fastener adapted to fasten the fixating member to the battery pack cover and a second fastener adapted to fasten the fixating member to the battery module, for securement within the recess of the battery module. A fastening direction of the first fastener is perpendicular to a fastening direction of the second fastener, and the first fastener is configured to move the fixating member into contact with the battery pack cover.

The first aspect of the disclosure may seek to provide an improved tolerance compensating fastening device for a battery pack. A technical benefit may include that the fastening device can be used for tolerance compensation, but without the risk of unfastening as the fixating member prevents momentum from being induced in the fasteners.

In some examples, the fixating member is plate shaped.

In some examples, the first fastener comprises a first threaded fastener, and the fixating member comprises a first threaded aperture for receiving the first threaded fastener. A technical benefit may include that the threaded fastener can be used to move the fixating member into tight contact with the battery pack cover and hold it there without the addition of further parts.

In some examples, the second fastener comprises a second threaded fastener, and the fixating member comprises a second threaded aperture for receiving the second threaded fastener.

According to a second aspect of the disclosure, a method for attaching a battery module to a battery pack cover is provided, the method comprising:
providing a battery pack cover, a battery module and a fastening device, the fastening device comprising a fixating member adapted to be received within, and protrude from, a recess of the battery module, a first fastener adapted to fasten the fixating member to the battery pack cover, and a second fastener adapted to fasten the fixating member to the battery module, for securement within the recess of the battery module,
arranging the fixating member of the fastening device in the recess of the battery module, allowing part of the fixating member to protrude from the recess,
fastening the first fastener, thereby moving the fixating member into contact with the battery pack cover, and
fastening the second fastener to fasten the fixating member within the recess of the battery module.

The second aspect of the disclosure may seek to provide an improved method for assembling a battery pack. A technical benefit may include that the fixating member can be arranged within the recess prior to positioning the battery module in the battery pack, and then moved into place with the first fastener. Thereby, assembly of the battery pack may be facilitated, while tolerances are accounted for.

In some examples, the first fastener comprises a first threaded fastener, and the fixating member comprises a first threaded aperture for receiving the first threaded fastener. A technical benefit may include that the threaded fastener can be used to move the fixating member into tight contact with the battery pack cover and hold it there without the addition of further parts.

In some examples, the second fastener comprises a second threaded fastener, and the fixating member comprises a second threaded aperture for receiving the second threaded fastener.

According to a third aspect of the disclosure, a battery pack for an electrical storage system is provided, the battery pack comprising a battery pack cover, a battery module and a fastening device, the fastening device comprising a fixating member, the fixating member being received within, and protruding from, a recess of the battery module. The fastening device of the third aspect further comprises a first fastener for fastening the fixating member to the battery pack cover, and a second fastener for fastening the fixating member to the battery module, for securement within the recess of the battery module. A fastening direction of the first fastener is perpendicular to a fastening direction of the second fastener and the first fastener is configured to move the fixating member into contact with the battery pack cover.

In some examples, the first fastener comprises a first threaded fastener, the fixating member comprises a first threaded aperture for receiving the first fastener, and the battery pack cover comprises a first through-hole for attaching the first threaded fastener to the battery pack cover.

In some examples, the second fastener comprises a second threaded fastener, the fixating member comprises a second threaded aperture for receiving the second threaded fastener, and the battery module comprises a second through-hole for attaching the second threaded fastener to the battery module.

In some examples, an extension of the second through-hole exceeds a length of the second fastener in the first fastening direction to allow fastening of the fixating member at different positions within the recess of the battery module.

A technical benefit may include that the second fastener can be positioned in varying positions to adapt to the position of the fixating member.

In some examples, the battery pack further comprises a first engaging member arranged at the battery module, a second engaging member arranged at the battery pack cover, and a third fastener wherein the first engaging member is configured to engage with the second engaging member to fixate the battery module to the battery pack cover in a first battery pack direction and a second battery pack direction, and the third fastener extending through the battery module to fixate the battery module to the battery pack cover in a third battery pack direction.

A technical benefit may include that the engaging members can be used to guide the battery module into a correct position and hold it there while fastening the fasteners.

In some examples, the first engaging member comprises a first protrusion and the second engaging member comprises a second protrusion, the second protrusion comprising a recess configured to engage with the first protrusion.

In some examples, the third fastener is a threaded fastener.

In some examples, the battery module comprises a third through-hole for attaching the third fastener to the battery module.

In some examples, the battery pack cover comprises a third threaded aperture for receiving the third fastener.

According to a fourth aspect an electrical storage system comprising a battery pack in accordance with the present disclosure is provided.

According to a fifth aspect, a vehicle comprising an electrical storage system in accordance with the present disclosure is provided.

The above aspects, accompanying claims, and/or examples disclosed herein above and later below may be suitably combined with each other as would be apparent to anyone of ordinary skill in the art.

Additional features and benefits are disclosed in the following description, claims, and drawings, and in part will be readily apparent therefrom to those skilled in the art or recognized by practicing the disclosure as described herein.

### BRIEF DESCRIPTION OF THE DRAWINGS

With reference to the appended drawings, below follows a more detailed description of aspects of the disclosure cited as examples.

FIG. 1 is a perspective view of an exemplary battery pack fastening device

FIG. 2 is a top view of an exemplary battery pack fastening device

FIG. 3 is a top view of an exemplary battery pack fastening device according to a second example

FIG. 4 is an exemplary method for fastening a battery module of a battery pack

### DETAILED DESCRIPTION

Aspects set forth below represent the necessary information to enable those skilled in the art to practice the disclosure.

The present disclosure aims at providing a fastening device which can be used for tolerance compensation without being subjected to unfastening. This is solved by a fastening device, battery pack and method as described below in relation to the disclosed figures.

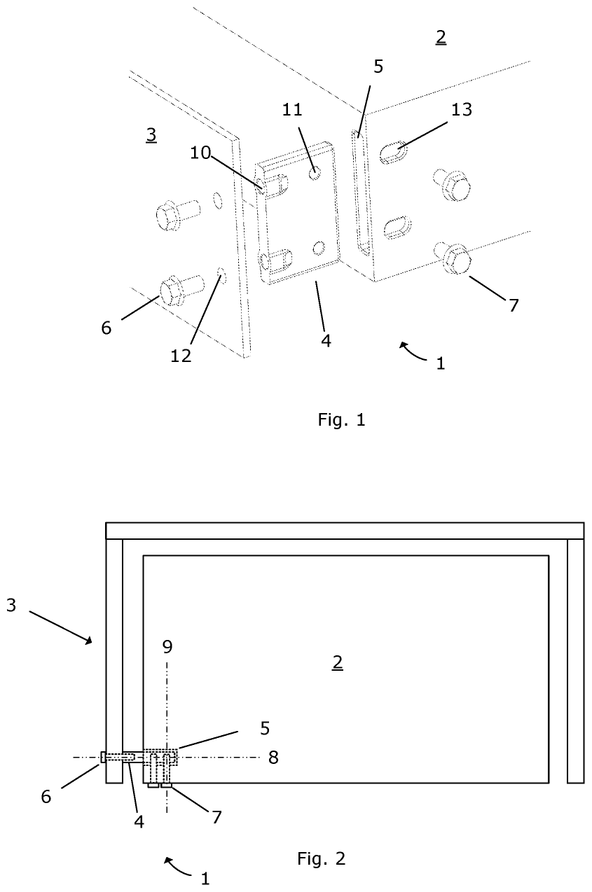

FIG. 1 shows a fastening device 1 for fastening of a battery module 2 to a battery pack cover 3. The fastening device 1 is arranged at a corner of the battery module 2 and may cooperate with additional fastening means for attaching the battery module 2. The fastening device 1 comprises a fixating member 4. The fixating member 4 is used to overcome a play between the battery module 2 and the battery pack cover 3. The play may be a result of tolerance differences during production.

The fixating member 4 is adapted to be received within a recess 5 of the battery module 2. The recess 5 is arranged in a side wall of the battery module 2 and is slightly shorter than the fixating member 4 such that the fixating member 4 protrudes from the recess 5 when being arranged within the recess 5.

The fixating member 4 is in the example fastened to the battery pack cover 3 with a pair of fasteners 6, such as a pair of bolts. The bolts extend through through-holes 12 of the battery pack cover 3 and is received by threaded apertures 10, the threaded apertures 10 comprising threads on an inner wall surface thereof and being disposed at one side of the fixating member 4. Fastening of the bolts moves the fixating member 4 into contact with the battery pack cover 3. The contact between the fixating member 4 and the battery pack cover 3, induced by the bolts, creates friction between the inner surface of the battery pack cover 3 and a side of the fixating member 4. Thereby movement of the fastening device 1, and momentum along the fastening direction of the first fasteners 6 can be avoided, by still adapting to tolerance differences.

The fastening device 1 of FIG. 1 further comprises a second fastener 7, in this case exemplified as a second pair of bolts. The bolts extend through a second pair of through-holes 13 and are received in threaded apertures 11 of the fixating member 4, the threaded apertures 11 comprising threads on an inner wall surface thereof. The second fastener 7 thus fastens the fixating member 4 to the battery module 2 within the recess 5, and the battery module 2 is thereby fastened to the battery pack cover 3 via the fastening device 1. The second through-holes 13 has a form which allows the second fastener 7 to adjust its position based on the position of the fixating member 4, thus being able to compensate for tolerance differences.

FIG. 2 shows a battery pack with a fastening device 1 in top view. In FIG. 2 the battery pack comprises a battery pack cover 3 surrounding the battery module 2 on at least three sides, and an opening at a fourth side. The opening is used for assembling the battery module 2 to the battery pack cover 3. The battery module 2 can thus be pushed into the battery pack cover 3 through the opening, whereby the fastening device 1 is used to fasten the battery module 2 to the battery pack cover 3. The fastening device 1 is exemplified as being arranged at a corner of the battery pack adjacent to the opening, where it can be easily accessed during assembly.

In FIG. 2, the fastening direction 8 of the first fastener 6 is perpendicular to the fastening direction 9 of the second fastener 7. The fixating member 4 is thereby attached from at least two direction which allows the fixating member 4 to be moved in the first fastening direction 8 using the first fastener 6 to compensate for tolerance differences, before being fastened in the second fastening direction 9 using the second fastener 7.

The recess 5 is in FIG. 2 shown to extend beyond the fixating member 4 when in fastened position. This is to allow the fixating member 4 to adjust its position within the recess 5 to compensate for tolerance differences.

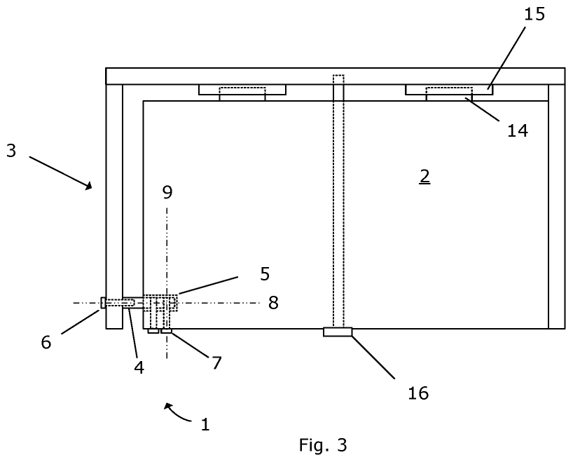

FIG. 3 shows the battery pack in top view according to a further example. In this example, additional fastening members is used to fasten the battery module 2 to the battery pack cover 3. The additional fastening members comprise a first engaging member 14 arranged on the battery module 2, a second engaging member 15 arranged on the battery pack cover 3, and a third fastener 16 extending through the battery module 2.

The additional fastening members could thus be used to further secure the battery module 2 to the battery pack cover 3 when needed. According to the solution shown in FIG. 3 the first engaging member 14 comprises a pair of first protrusions arranged on the battery module 2, the first protrusions being adapted to engage with a pair of second engaging members 15 of the battery cover 3, the second engaging members 15 comprising a second pair of protrusions, the second protrusions comprising a central groove for receiving the first protrusions. The first and second engaging members 14, 15 thus fixate the battery module 2 to the battery cover 3 in a first and second battery pack direction. Alternatively, the engaging members 14, 15 could be constructed in other ways as long as they fixate the battery module 2 to the battery pack cover 3 in at least two directions. For example, the groove could instead be provided on the first engagement members 14. The third fastener 16, which in the present example is exemplified as a bolt, further fastens the battery module in a third battery pack direction.

It is understood that the examples of FIG. 2 and FIG. 3 may comprise further additional fastening devices. For example, the fastening device 1 could alternatively be arranged to fasten the side of the battery module being opposite to that shown in in FIG. 2 and FIG. 3. However, this side could alternatively be secured tightly to the battery cover 3 without the use of any additional tolerance compensating device.

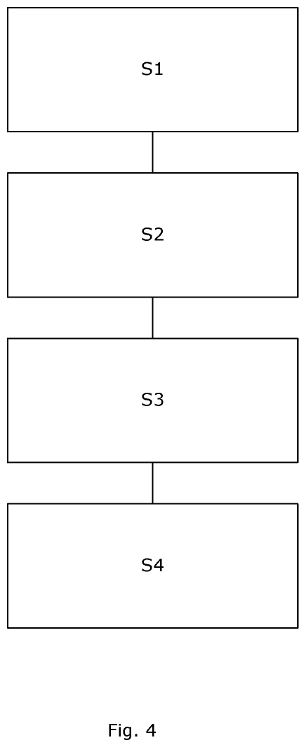

In FIG. 4 a method for fastening a battery module 2 to a battery pack cover 3 using a fastening device 1 is illustrated. In step S1 a battery module, a battery pack cover 3 and a fastening device 1 in accordance with the present disclosure are provided. In step S2 the fixating device 4 of the fastening device 1 is inserted into the recess 5 of the battery module 2. Preferably, the fixating member 4 is arranged within the recess 5 prior to positioning the battery module 2 into the battery pack cover 3. When the battery module 2 has been positioned in the battery pack cover 3 the first fastener 6 is fastened S3. The fastening S3 of the first fastener 6 moves the fixating member 4 towards and into contact with the cover 3. The fixating member 4 is guided by the walls of the recess 5 during the movement, so that the fixating member 5 slides linearly towards the cover 3. After having positioned the fixating member 4 in relation to the cover 3 by use of the first fastener 6, the second fastener 7 is fastened S4 which fastens the fixating member 4 to the battery module 2.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure concepts being set forth in the following claims.

What is claimed is:

1. A fastening device configured to fasten a battery module to a battery pack cover, the fastening device comprising
a fixating member adapted to be received within, and protrude from, a recess of the battery module,
a first fastener adapted to fasten the fixating member to the battery pack cover, and
a second fastener adapted to fasten the fixating member to the battery module, for securement within the recess of the battery module,
wherein a fastening direction of the first fastener is perpendicular to a fastening direction of the second fastener, and
wherein the first fastener is configured to move the fixating member into contact with the battery pack cover.

2. The fastening device according to claim 1, wherein the fixating member is plate shaped.

3. The fastening device according to claim 1, wherein the first fastener comprises a first threaded fastener, and wherein the fixating member comprises a first threaded aperture for receiving the first threaded fastener.

4. The fastening device according to claim 1, wherein the second fastener comprises a second threaded fastener, and wherein the fixating member comprises a second threaded aperture for receiving the second threaded fastener.

5. A method for attaching a battery module to a battery pack cover, the method comprising
providing a battery pack cover, a battery module and a fastening device, the fastening device comprising
a fixating member adapted to be received within, and protrude from, a recess of the battery module,
a first fastener adapted to fasten the fixating member to the battery pack cover, and
a second fastener adapted to fasten the fixating member to the battery module, for securement within the recess of the battery module,
arranging the fixating member of the fastening device in the recess of the battery module, allowing part of the fixating member to protrude from the recess,
fastening the first fastener, thereby moving the fixating member into contact with the battery pack cover, and
fastening the second fastener to fasten the fixating member within the recess of the battery module.

6. The method according to claim 5, wherein the fixating member is plate shaped.

7. The method according to claim 5, wherein the first fastener comprises a first threaded fastener, and wherein the fixating member comprises a first threaded aperture for receiving the first threaded fastener.

8. The method according to claim 6, wherein the second fastener comprises a second threaded fastener, and wherein the fixating member comprises a second threaded aperture for receiving the second threaded fastener.

9. A battery pack for an electrical storage system, the battery pack comprising
a battery pack cover,
a battery module, and
a fastening device, the fastening device comprising
a fixating member, the fixating member being received within, and protruding from, a recess of the battery module,
a first fastener for fastening the fixating member to the battery pack cover, and
a second fastener for fastening the fixating member to the battery module, for securement within the recess of the battery module,
wherein a fastening direction of the first fastener is perpendicular to a fastening direction of the second fastener, and
wherein the first fastener is configured to move the fixating member into contact with the battery pack cover.

10. The battery pack according to claim 9, wherein the fixating member is plate shaped.

11. The battery pack according to claim 9, wherein the first fastener comprises a first threaded fastener, wherein the fixating member comprises a first threaded aperture for receiving the first fastener, and wherein the battery pack cover comprises a first through-hole for attaching the first fastener to the battery pack cover.

12. The battery pack according to claim 9, wherein the second fastener comprises a second threaded fastener, wherein the fixating member comprises a second threaded aperture for receiving the second threaded fastener, and wherein the battery module comprises a second through-hole for attaching the second threaded fastener to the battery module.

13. The battery pack according to claim 12, wherein an extension of the second through-hole exceeds a length of the second fastener in the first fastening direction to allow fastening of the fixating member at different positions within the recess of the battery module.

14. The battery pack according to claim 9 further comprising
a first engaging member arranged at the battery module,
a second engaging member arranged at the battery pack cover, and
a third fastener,
wherein the first engaging member is configured to engage with the second engaging member to fixate the battery module to the battery pack cover in a first battery pack direction and a second battery pack direction, and
wherein the third fastener extends through the battery module to fixate the battery module to the battery pack cover in a third battery pack direction.

15. The battery pack according to claim 14 wherein the first engaging member comprises a first protrusion and the second engaging member comprises a second protrusion, the second protrusion comprising a recess configured to engage with the first protrusion.

16. The battery pack according to claim 14 wherein the third fastener is a threaded fastener.

17. The battery pack according to claim 14 wherein the battery module comprises a third through-hole for attaching the third fastener to the battery module.

18. The battery pack according to claim 14 wherein the battery pack cover comprises a third threaded aperture for receiving the third fastener

19. An electrical storage system comprising the battery pack according to claim 9.

20. A vehicle comprising the electrical storage system according to claim 19.
